(19) United States
(12) Patent Application Publication
(10) Pub. No.: US 2016/0283442 A1
(43) Pub. Date: Sep. 29, 2016

(54) SYSTEM AND METHOD FOR PREDICTING TRANSFORMATIVE EVENTS IN MULTIVARIABLE SYSTEMS

(71) Applicant: The George Washington University a Congressionally Chartered Not-for-Profit Corporation, Washington, DC (US)

(72) Inventors: Chenghang Du, Vienna, VA (US); Chen Zeng, Rockville, MD (US)

(21) Appl. No.: 14/668,814

(22) Filed: Mar. 25, 2015

(51) Int. Cl. G06F 17/18; G06F 19/00

(52) U.S. Cl. CPC G06F 17/18; G06F 19/345

(57) ABSTRACT

A method of predicting a transformative event within a multivariable system includes receiving values for each of a plurality of variables of the multivariable system for a plurality of measurement times over a measurement time period; selecting a plurality of agitated variables as a sub-set of the plurality of variables; calculating a cross correlation coefficient between each pair of agitated variables from the plurality of agitated variables; identifying connected pairs of agitated variables based on the cross correlation coefficients; identifying all clusters of agitated variables such that each agitated variable within each cluster of agitated variables is a connected pair of agitated variables with at least one other agitated variable therein; identifying a percolating cluster of variables as the largest cluster of agitated variables from all clusters of agitated variables identified for the corresponding measurement time; receiving at least one nucleation core variable that is known to be associated with the transformative event; identifying all occurrences of the at least one nucleation core variable in each percolating cluster for each of the plurality of measurement times; calculating a nucleation index based on said all occurrences of the at least one nucleation core variable identified in each percolating cluster for each of the plurality of measurement times; comparing the nucleation index with a predetermined event index; and predicting the transformative event based on the comparing.

### CROSS-REFERENCE TO RELATED APPLICATIONS

This application claims priority to U.S. Provisional Application No. 61/970,072 filed Mar. 25, 2014, the entire content of which is hereby incorporated by reference.

This invention was made with Government support under Grant No. CDI-0941228, awarded by the National Science Foundation (NSF). The Government has certain rights in the invention.

### BACKGROUND

1. Technical Field

The current invention relates to systems and methods for predicting transformative events in multivariable systems.

2. Discussion of Related Art

Beyond technological challenges in big data infrastructure, one major bottleneck of data driven discovery lies in the theoretical formulation and its algorithmic derivative in detecting, manipulating, and understanding sudden system-wide transitions. Such examples range from large-scale financial and social instability to drastic deterioration of complex disease.

In statistical physics, a critical transition is the onset of non-trivial macroscopic or collective spatial behavior out of a large number of microscopic elements. In nonlinear dynamics, sudden transition in bifurcation leads to qualitative change in temporal behavior for a set of critical parameters.

Most traditional time series algorithms only apply to short or medium time scales when the underlying causal relationship between system variables is well approximated as stationary. However, this static picture breaks down at the criticality. There fore, there remains a need for improved systems and methods for predicting transformative events in multivariable systems.

### SUMMARY

A method of predicting a transformative event within a multivariable system according to an embodiment of the current invention includes receiving values for each of a plurality of variables of the multivariable system for a plurality of measurement times over a measurement time period; selecting, for each of the plurality of measurement times, a plurality of agitated variables as a sub-set of the plurality of variables; calculating, for each of the plurality of measurement times, a cross correlation coefficient between each pair of agitated variables from the plurality of agitated variables; identifying connected pairs of agitated variables based on the cross correlation coefficients; identifying, for each of the plurality of measurement times, all clusters of agitated variables such that each agitated variable within each cluster of agitated variables is a connected pair of agitated variables with at least one other agitated variable therein; identifying, for each of the plurality of measurement times, a percolating cluster of variables as the largest cluster of agitated variables from all clusters of agitated variables identified for the corresponding measurement time; receiving at least one nucleation core variable that is known to be associated with the transformative event; identifying all occurrences of the at least one nucleation core variable in each percolating cluster for each of the plurality of measurement times; calculating, for each of the plurality of measurement times, a nucleation index based on said all occurrences of the at least one nucleation core variable identified in each percolating cluster for each of the plurality of measurement times; comparing, for each of the plurality of measurement times, the nucleation index with a predetermined event index; and predicting the transformative event based on the comparing. The selecting, for each of the plurality of measurement times, the plurality of agitated variables includes calculating a measure of time variation of each of the plurality of variables for a local time period around each of the plurality of measurements times such that the local time period is smaller than the measurement time period.

A non-transient computer-readable medium according to an embodiment of the current invention includes computer-executable code for predicting a transformative event within a multivariable system. The computer-executable code, when executed by a computer, causes the computer to receive values for each of a plurality of variables of the multivariable system for a plurality of measurement times over a measurement time period; select, for each of the plurality of measurement times, a plurality of agitated variables as a sub-set of the plurality of variables; calculate, for each of the plurality of measurement times, a cross correlation coefficient between each pair of agitated variables from the plurality of agitated variables; identify connected pairs of agitated variables based on the cross correlation coefficients; identify, for each of the plurality of measurement times, all clusters of agitated variables such that each agitated variable within each cluster of agitated variables is a connected pair of agitated variables with at least one other agitated variable therein; identify, for each of the plurality of measurement times, a percolating cluster of variables as the largest cluster of agitated variables from all clusters of agitated variables identified for the corresponding measurement time; receive at least one nucleation core variable that is known to be associated with the transformative event; identify all occurrences of the at least one nucleation core variable in each percolating cluster for each of the plurality of measurement times; calculate, for each of the plurality of measurement times, a nucleation index based on said all occurrences of the at least one nucleation core variable identified in each percolating cluster for each of the plurality of measurement times; compare, for each of the plurality of measurement times, the nucleation index with a predetermined event index; and predict the transformative event based on the comparing. The selecting, for each of the plurality of measurement times, the plurality of agitated variables includes calculating a measure of time variation of each of the plurality of variables for a local time period around each of the plurality of measurements times such that the local time period is smaller than the measurement time period.

A system for predicting a transformative event within a multivariable system according to an embodiment of the current invention includes a computer. The computer is configured to receive values for each of a plurality of variables of the multivariable system for a plurality of measurement times over a measurement time period; select, for each of the plurality of measurement times, a plurality of agitated variables as a sub-set of the plurality of variables; calculate, for each of the plurality of measurement times, a cross correlation coefficient between each pair of agitated variables from the plurality of agitated variables; identify connected pairs of agitated variables based on the cross correlation coefficients; identify, for each of the plurality of measurement times, all clusters of agitated variables such that each agitated variable within each cluster of agitated variables is a connected pair of agitated variables with at least one other agitated variable therein; identify, for each of the plurality of measurement times, a percolating cluster of variables as the largest cluster of agitated variables from all clusters of agitated variables identified for the corresponding measurement time; receive at least one nucleation core variable that is known to be associated with the transformative event; identify all occurrences of the at least one nucleation core variable in each percolating cluster for each of the plurality of measurement times; calculate, for each of the plurality of measurement times, a nucleation index based on said all occurrences of the at least one nucleation core variable identified in each percolating cluster for each of the plurality of measurement times; compare, for each of the plurality of measurement times, the nucleation index with a predetermined event index; and predict the transformative event based on said comparing. The selecting, for each of the plurality of measurement times, the plurality of agitated variables includes calculating a measure of time variation of each of the plurality of variables for a local time period around each of the plurality of measurements times such that the local time period is smaller than the measurement time period.

### BRIEF DESCRIPTION OF THE DRAWINGS

FIG. 1 is a flowchart to help explain a method for predicting transformative events in multivariable systems according to an embodiment of the current invention.

FIG. 2 shows percolating clusters (black nodes with connecting links) as transition cores consisting of agitated and synchronized genes, at different time points in muscle regeneration for a particular example according to an embodiment of the current invention.

FIG. 3 shows the enrichment of muscle-associated genes at different time points in muscle regeneration for the example of FIG. 2. Three time points—day 3, 4.5 and 11, respectively—are significantly enriched.

FIG. 4 shows the enriched (p<0.05) gene ontology at day 3 for the example of FIG. 2.

FIG. 5 shows the enriched (p<0.05) gene ontology at day 4.5 for the example of FIG. 2.

FIG. 6 shows the enriched (p<0.05) gene ontology at day 11 for the example of FIG. 2.

FIG. 7 shows the refined transition core at day 3, which is constructed based on existing functional interactions among the percolating cluster. Functional interactions were retrieved from Reactome database. Red nodes stand for nucleation sites that form close community structure with similar muscle-related functions.

FIG. 8 is similar to FIG. 7 except for day 4.5.

FIG. 9 is similar to FIG. 7 except for day 11.

FIG. 10 shows gene expression of nucleation sites at day 3.

FIG. 11 shows gene expression of nucleation sites at day 4.5.

FIG. 12 shows gene expression of nucleation sites at day 11.

FIG. 13 shows the index change of nucleation sites at day 3 (purple), 4.5 (green), and 11 (red), respectively. Identified four peaks correspond to the beginning of four different stages of muscle regeneration, suggesting substantial predictive power for early detection.

FIG. 14 shows the clinical symptom chart of corresponding subjects (rows) and times (columns) after inoculation of influenza virus for another example according to an embodiment of the current invention. Larger numbers indicate clinically more severe symptoms.

FIG. 15 shows 17 influenza-infected subjects can be clustered into symptomatic and asymptomatic groups that are consistent with clinical symptoms. The clustering is based on individual genes' standard deviations over the entire period of observation according to an embodiment of the current invention.

FIG. 16 shows the percolating cluster of 45 genes (black nodes) that act as transition core of disease progression.

FIG. 17 shows among the percolating cluster of 45 genes, 12 are related to immune response to virus and constitute the nucleation sites (highlighted in red).

FIG. 18 shows the enriched gene ontologies (p<0.01) for the percolating cluster of 45 genes.

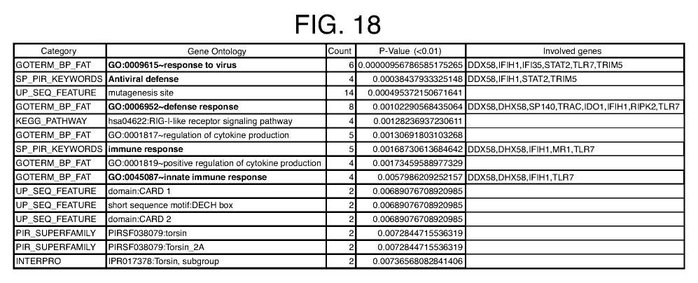

FIG. 19 shows the index change of the nucleation sites of 12 genes for 9 symptomatic subjects during the disease progression.

FIG. 20 is similar to FIG. 19 except for 8 asymptomatic subjects.

FIG. 21 shows the gene expression change of the nucleation core for 9 symptomatic subjects during the disease progression.

FIG. 22 is similar to FIG. 21 except for 8 asymptomatic subjects.

FIG. 23 shows the comparison of index change and severity of clinical symptoms for 9 symptomatic subjects during disease progression. The onset of disease is almost always preceded with the rise of index. The severity of clinical symptoms can be also reflected by the magnitude of index.

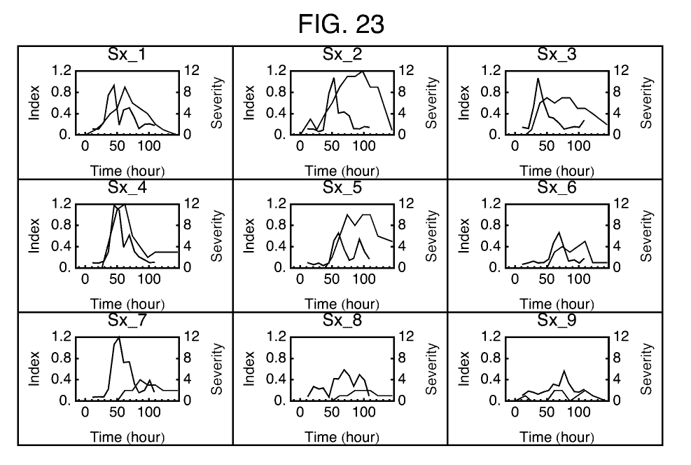

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention.

All references cited anywhere in this specification are incorporated by reference as if each had been individually incorporated.

The term “transformative event” in multivariable systems can include a critical transition, for example. It can include, but is not limited to, the onset of disease, stages in a healing or recovery process, or a stock market crash, for example.

Insights often observed at critical transition such as dramatic dimensionality reduction, scaling invariance, and universality classes provide inspiration for some embodiments of the current invention.

In contrast to conventional approaches, an embodiment of the present invention can provide an orthogonal algorithm aiming to derive effective low-dimensional description of the transition core that captures the large-scale and/or long-time behavior of evolving big data set.

Accordingly, an embodiment of the current invention utilizes an algorithm of identifying from multi-dimensional data sets the transition core of system variables that precede and drive imminent critical transitions. Applications can include, but are not limited to, early detection of complex diseases. Examples of methods according to some embodiments of the current invention are provided herein for detecting stage transitions in muscle regenerative processes and predicting the onset of influenza during disease progression.

Beyond technological challenges in big data infrastructure, one major bottleneck of data driven discovery lies in the theoretical formulation and its algorithmic derivative in detecting, manipulating, and understanding sudden system-wide transitions. Such examples range from large-scale financial and social instability to drastic deterioration of complex disease.

In statistical physics, a critical transition is the onset of non-trivial macroscopic or collective spatial behavior out of a large number of microscopic elements. In nonlinear dynamics, sudden transition in bifurcation leads to qualitative change in temporal behavior for a set of critical parameters. Insights often observed at critical transition such as dramatic dimensionality reduction, scaling invariance, and universality classes provide inspiration for the present invention.

Most traditional time series algorithms only apply to short or medium time scales when the underlying causal relationship between system variables is well approximated as stationary. However, this static picture breaks down at the criticality. In contrast, an embodiment of the present invention provides an orthogonal algorithm aiming to derive effective low-dimensional description of the transition core that captures the large-scale and/or long-time behavior of evolving big data set.

Therefore, an embodiment of the present algorithm targets specifically those comparatively long-term processes with time-evolving organization of components, particularly those under dramatic changes at critical points. Such phase transitions occur ubiquitously at all levels of biological systems, from microscopic protein folding, to mesoscopic cell differentiation, and to macroscopic tissue development. As initial examples, embodiments of the current invention were applied to analyze genome-wide gene expression data of the regenerative process of muscle tissues and the disease progression of influenza. It not only exhibited efficiency in handling high-throughput genomic data, but also demonstrated great capabilities of predicting imminent transitions as well as the deeper causal effects.

To illustrate some concepts according to some embodiments of the current invention, one considers the water-ice transition. A t the transition, the density becomes “agitated” and shows large fluctuation because it can be that of water or ice, and the fluctuation dies off at either stable phase. At the same time, there are pieces of ice of all sizes floating in the water with the largest one being the so-call giant component or transition core that percolates the system. The presence of scaling invariance, i.e., events at all scales is the hallmark of criticality. Making analogies to these observations from statistical physics of phase transition, we implemented an embodiment of the current invention to identify certain time points when a set of genes collectively become “agitated” and “move” in unison to form a giant component as the transition core. The drivers that initiate the formation of this percolating cluster (i.e., the giant component) are the nucleation genes of most significance.

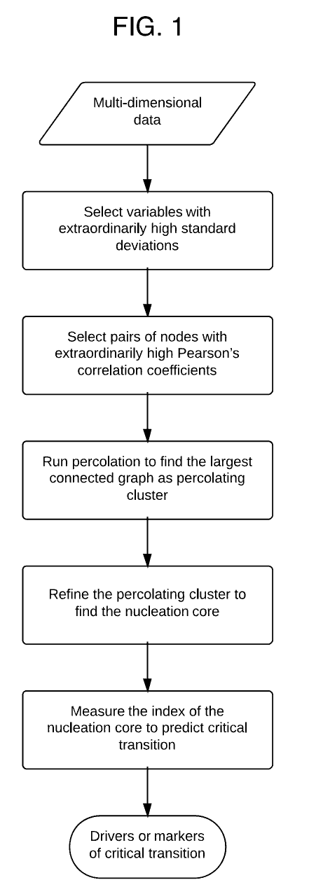

Some embodiments of the current invention can provide not only a theoretical intuition but also algorithmic implementations in handling a particular class of big-data that captures large-scale sudden transition. Identification of a transition core and its nucleation sites can form the dynamic markers for diagnostic tools to detect onset signals of complex disease or social and natural catastrophe or financial crisis. The steps of a method according to an embodiment of the current invention are briefly described in the flowchart shown in FIG. 1.

As is illustrated in the flowchart of FIG. 1, a method of predicting a transformative event within a multivariable system according to an embodiment includes receiving values for each of a plurality of variables of the multivariable system for a plurality of measurement times over a measurement time period. This is labeled “Multi-dimensional data” in FIG. 1. The data can be previously obtained and stored data, for example, or it could be data taken in real time, or a combination of both. The method also includes selecting, for each of the plurality of measurement times, a plurality of agitated variables as a sub-set of the plurality of variables. This corresponds to the next box down in FIG. 1, which refers to a particular embodiment. More generally, the selecting of the plurality of agitated variables, for each of said plurality of measurement times, includes calculating a measure of time variation of each of the plurality of variables for a local time period around each of the plurality of measurement times such that the local time period is smaller than the measurement time period. A standard deviation is just one way of quantifying the variability of the parameter for local times around the measurement time. This selecting step can include, but is not limited to, calculating a standard deviation over a period of time that includes the measurement time plus each of the closest surrounding times. Furthermore, one could set a threshold for the degree of variation in the parameter.

The method also includes calculating, for each of the plurality of measurement times, a cross correlation coefficient between each pair of agitated variables from the plurality of agitated variables. The correlation calculations will be described in more detail for some embodiments below. The method also further includes identifying connected pairs of agitated variables based on said cross correlation coefficients; identifying, for each of the plurality of measurement times, all clusters of agitated variables such that each agitated variable within each cluster of agitated variables is a connected pair of agitated variables with at least one other agitated variable therein; identifying, for each of the plurality of measurement times, a percolating cluster of variables as the largest cluster of agitated variables from all clusters of agitated variables identified for the corresponding measurement time; receiving at least one nucleation core variable that is known to be associated with the transformative event; and identifying all occurrences of the at least one nucleation core variable in each percolating cluster for each of the plurality of measurement times. Although there is at least one known nucleation core variable, the concepts of the current invention are not limited by the particular number of known nucleation core variables. In general, there can be any number suitable for a particular application.

The method further includes calculating, for each of the plurality of measurement times, a nucleation index based on said all occurrences of the at least one nucleation core variable identified in each percolating cluster for each of the plurality of measurement times; comparing, for each of the plurality of measurement times, the nucleation index with a predetermined event index; and predicting the transformative event based on the comparing.

According to some embodiments of the current invention, an early prediction of transformations in complex systems can be provided. For example, the change in state of a biological system, such as, but not limited to, changing from a healthy state to a diseased state, or vice versa. Another example can be a change in an economic system, such as a stable stock market to a collapsing stock market. Other examples can include, but are not limited to, sudden and often catastrophic changes in ecosystems, climate systems, and physiological systems.

In some embodiments, the identifying connected pairs of agitated variables based on the cross correlation coefficients uses a threshold value for the cross correlation coefficients that, when exceeded in magnitude, identifies the corresponding pairs of agitated variables to be connected. In some embodiments, the threshold value for the cross correlation coefficients is selected such that exactly N/2 pairs of the agitated variables are identified as connected among N agitated variables selected.

The general concepts of the current invention are not limited by a particular number of the plurality of variables. For example, the plurality of variables can be any plurality according to the particular system such as, but not limited to, at least 100 variables, at least 1000 variables, at least 10,000 variables, at least 100,000 variables, at least 1 million variables, or even more.

Although the method described above uses at least one known nucleation core variable to predict a transformative event of the multivariate system, another embodiment can use a similar process with a known transformative event to extract nucleation core variables associated with the event. For example, an embodiment of the current invention can be applied to known outcomes of biological systems to extract biomarkers, such as, but not limited to, biomarkers for developing cancer or other rare diseases.

The following describes the implementation of some specific embodiments in some more detail.

Standard Deviation and Pearson's Correlation Coefficient.

Standard deviation σ can be used to evaluate the fluctuation of a single gene during a certain period of time. It follows the conventional definition as

σ=\sqrt{E[X²]−(E[X])²},

where X={X₁, X₂, . . . , X_{T}} is the time course expression level for one particular gene over T discretized time points.

Pearson's correlation coefficient is used to measure the co-movement between two genes over time. The definition follows as

$$r = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}} ,$$

where X={X₁, X₂, . . . , X_{T}} and Y={Y₁, Y₂, . . . , Y_{T}} are measurements of two genes along the T time points.

Abnormality and Z-Score.

Z-score measure is used to quantify the abnormality of correlation/standard deviation at a given time point. For a sequence of N measurements of standard deviation σ or correlation r, Z-score z is calculated for each of the measurements. For example, for σ={σ₁, σ₂, . . . }, the corresponding Z-score sequence would be

$${z}_{i} = \frac{( {σ}_{i} - {μ}_{σ} )}{{σ}_{σ}} ,$$

where μ_{σ} is the average of σ over the sequence of N measurements and σ_{σ} is the standard deviation for these measurements. Similarly, Z-scores can be calculated for a sequence of correlation measurements.

In practice, for measurements of gene expression level over T time points, we shift a window of N (N<T) of measurements along the time series, and calculate standard deviations, correlation coefficients and their Z-scores accordingly.

Percolation-Based Approach.

The algorithm provides not only a theoretical intuition but also algorithmic implementation in handling a particular class of big-data that captures large-scale sudden transition. Identification of transition core and its nucleation sites can form the dynamic markers for diagnostic tools to detect onset signals of complex disease. The steps of a method according to an embodiment of the current invention are briefly described in the flowchart shown in FIG. 1.

More specifically, the steps in an early detection method in microarray data analysis according to an embodiment of the current invention are detailed below:
1. Fluctuation selection. Among time course gene expression data (usually about 10,000 genes), at each specified time window (3 or 5 time points), choose genes with extraordinarily high fluctuation, i.e., genes with higher standard deviation comparing to other time windows. In practice, we calculate the standard deviation of a fixed number of measurements and shift this window through the time course to generate a series of standard deviation values. The standard deviation time series are then converted into z-scores. For a focal time point, we rank the genes by their corresponding z-scores and select such genes with highest z-scores.
2. Correlation selection. In every time window considered, we have a set of usually fluctuating genes as potential candidates for biomarkers. We now calculate the Pearson correlation coefficients between any pairwise genes in this set, i.e., compute the correlation matrix. We obtain such correlation matrix in every shifted time window that is concerned. For each value (pairwise correlation coefficient) in the matrix, we convert it into z-score by comparing and normalizing with the values in other time windows. A time series of z-score matrices are therefore constructed. This step allows us to build a network topology representing overly correlating interactions among focal genes for each time window.
3. Percolation. A percolation procedure is then implemented on the networks created in the previous step. In practice, for each network in a particular time window, we select N/2 gene pairs and connect them in the graph. Here N is the number of genes being selected in the step 1. Based on the percolation theory of random graph, when edge to node ratio reaches a level of ½, a giant component starts to emerge. We then run a flood fill algorithm on the graph to select the largest component of genes. Again, we obtain one such giant component of genes or percolating cluster of genes at each time window. Presence of such a percolating (giant-component) may help synchronize the system's dynamical behavior, another hallmark of critical phase transition.
4. Gene ontology and Reactome refinement. The giant component of genes is refined by gene ontology analysis and functional reaction database. In practice, we used program David for conducting gene ontology analysis and Reactome database for functional interaction mapping. We then pick gene clusters with particular functionalities that are related to the disease we are interested and use these nucleation site genes as new biomarkers for later prediction.
5. Composite index and prediction. We defined later the composite index as the product of averaged standard deviation and averaged correlation among a group of genes. For the biomarker we identify in the previous step, we compute this composite index of these biomarkers and evaluate how this index changes over time. An uprise of such index may indicate an upcoming sudden transition, e.g., the onset of disease.

Composite Index.

A composite index involving standard deviation and correlation coefficient has been introduced to quantify the chance of an upcoming sudden event. Here, we define a slightly different composite index, whose uprise in quantity indicates a higher likelihood of an imminent phase transition. The composite index CI according to an embodiment of the current invention is defined as

CI=|PCC|·|SD|,

where |PCC|(|SD|) stands for the average of Pearson correlation coefficients (standard deviations) among the group of driver variables or nucleation site genes that are identified by the above algorithm.

Another embodiment of the current invention is directed to a non-transient computer-readable medium that includes computer-executable code for predicting a transformative event within a multivariable system. When the computer-executable code is executed by a computer, it causes the computer to perform the steps of the methods described above. The term computer is intended to have a broad definition. It can be a hand-held device, such as a smart phone, a tablet computer, a laptop computer, a desktop computer, a workstation and/or any number of such devices connected over a network. The network can be a hard-wired network, a wireless network, a local area network (LAN), a wide area network (WAN), and/or the internet, for example. The computer can include a data processor, such as a central processing unit (CPU) and/or multiple processors in any serial or parallel architecture. The computer can also include memory and data storage.

Another embodiment of the current invention is directed to a system that includes a computer that has a data processor configured to execute instructions to perform the steps according to an embodiment of the current invention. The computer can run computer-executable code in some embodiments, or it can be hard-wired to perform the functions described above.

The following describes some examples applying some embodiments of the current invention. The broad concepts of the current invention are not limited to the particular examples.

### EXAMPLES

The algorithm was first applied to study the regenerative process of muscle tissues, understanding of which is critical for the diagnosis as well as the treatment of muscular diseases such as Duchenne muscular dystrophy—a disease resulting 1 out of 3,600 boys in muscle degradation and eventual death. The time series data was retrieved from GEO database with accession ID GSE469, consisting of expression data of ˜12,000 genes over a 40-day period right after toxic damages on mouse muscle tissues.

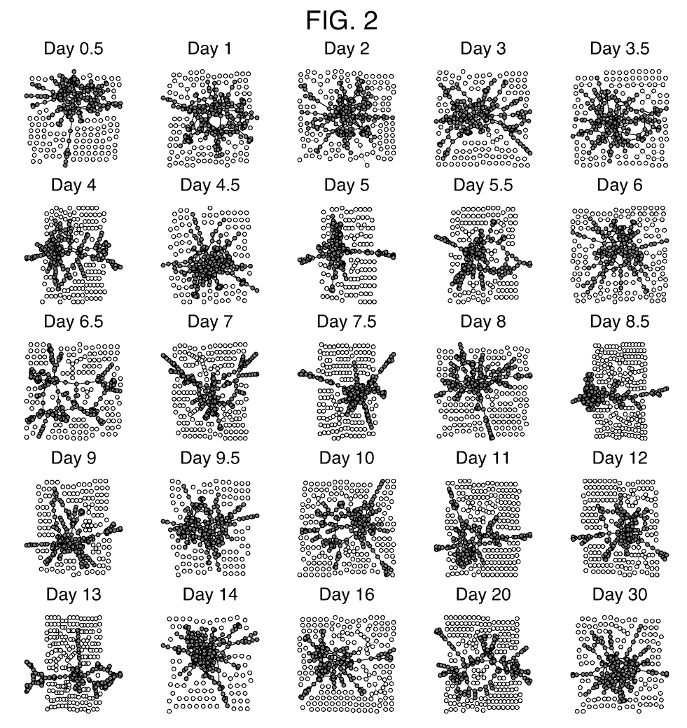

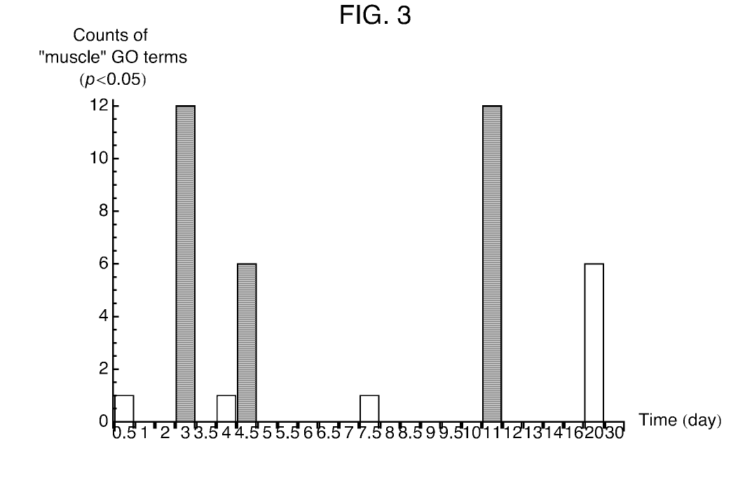

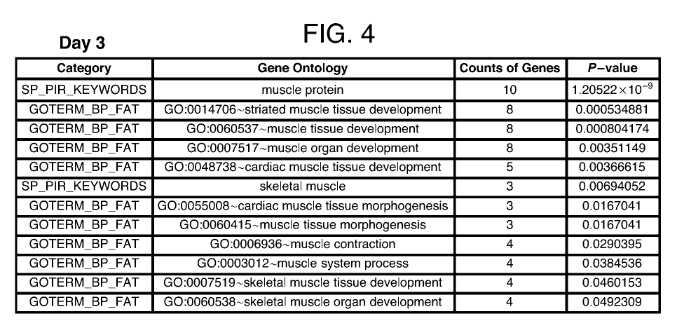

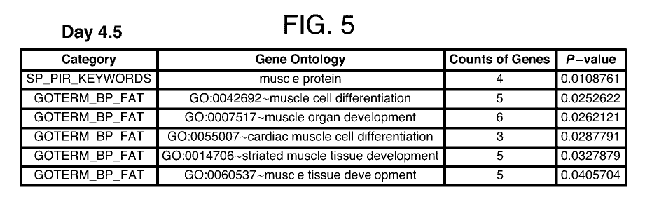

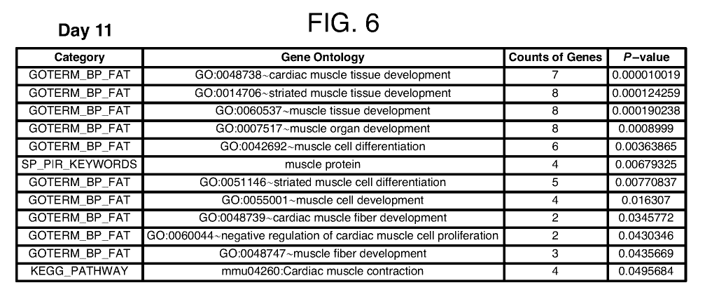

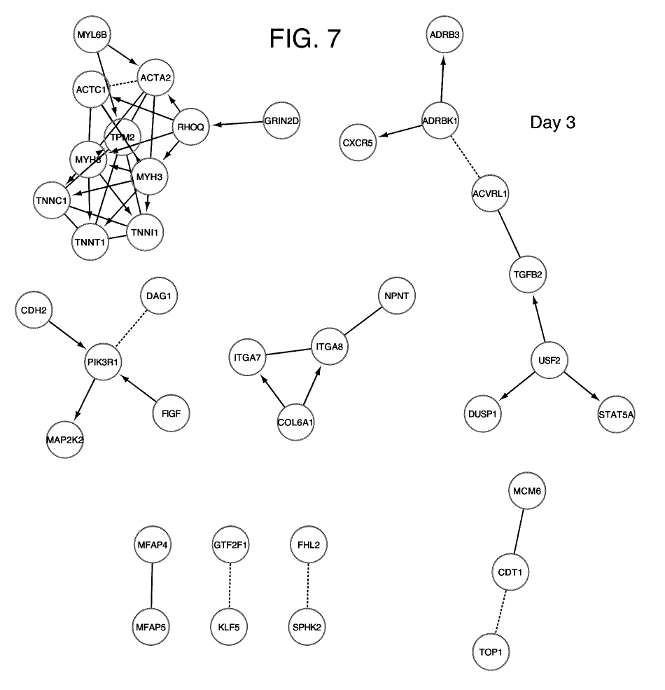

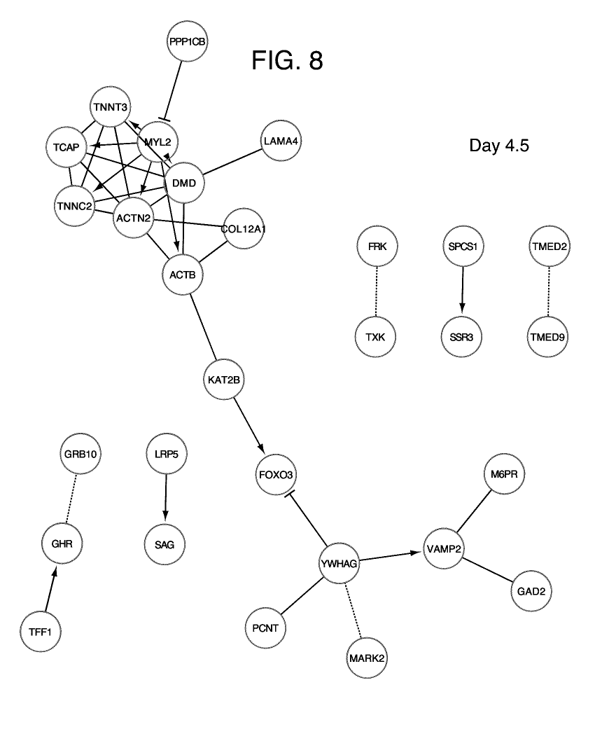

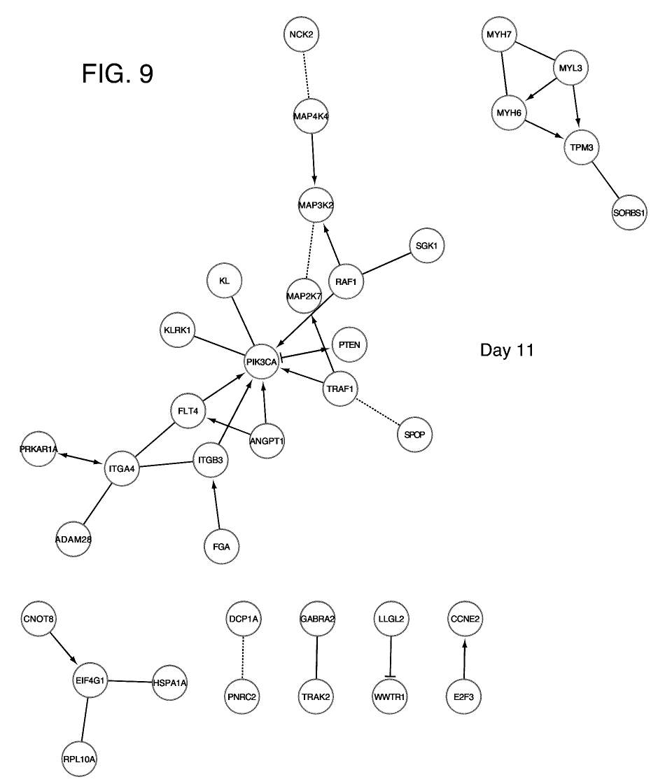

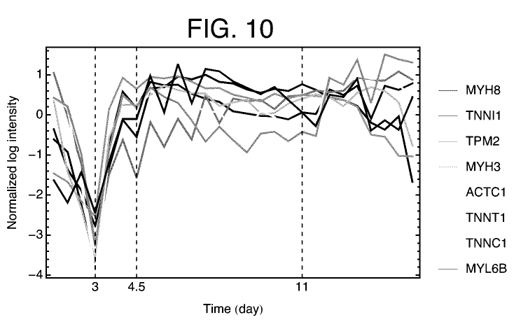

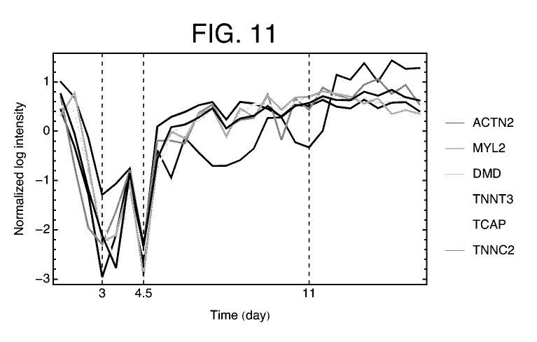

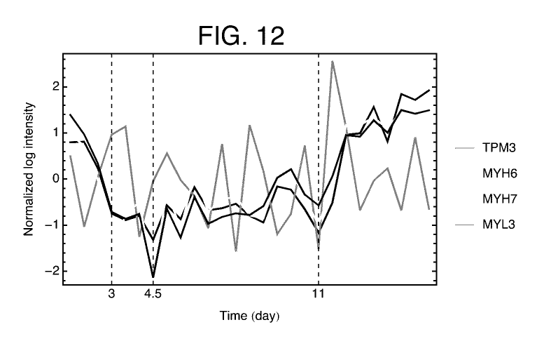

Applying the algorithm to analyze the above gene expression data, we identified candidate percolating clusters as transition cores at different time points (FIG. 2). We identified in this fashion three critical time points (day 3, 4.5 and 11, respectively) where muscle-associated genes are enriched (see FIG. 3-6) and form the nucleation sites in the giant transition core (see FIG. 7-9). One can see that at each of these critical points, the nucleation genes collectively become “agitated” and “move” together in an unusually synchronized fashion (see FIG. 10-12).

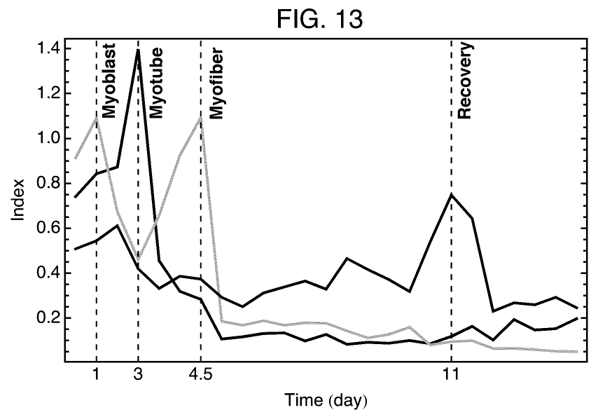

To quantify the behavior of nucleation sites for prediction purposes, we defined a composite index CI=|SD|*|PCC| as the product of averaged standard deviations of nucleation genes and averaged absolute Pearson's correlation coefficients between the nucleation genes. Larger value of such index indicates higher likelihood of an imminent critical transition. The index change for the above three sets of nucleation genes is shown in FIG. 13, There are four critical phases identified, corresponding to the four peaks out of the three index curves. The first three phases (at day 1, 3 and 4.5, respectively) correspond to the beginning of three well-known stages in muscle regeneration (myoblast proliferation, myotube formation and myofiber maturation, respectively). A fourth and novel phase (day 11) was also identified. Indeed, the protein products of genes identified in this fourth phase, e.g., myosin, tropomyosin, and troponin, are building blocks of myofilaments that support the sliding movement between muscle tissues, suggesting the regenerated muscular functionality.

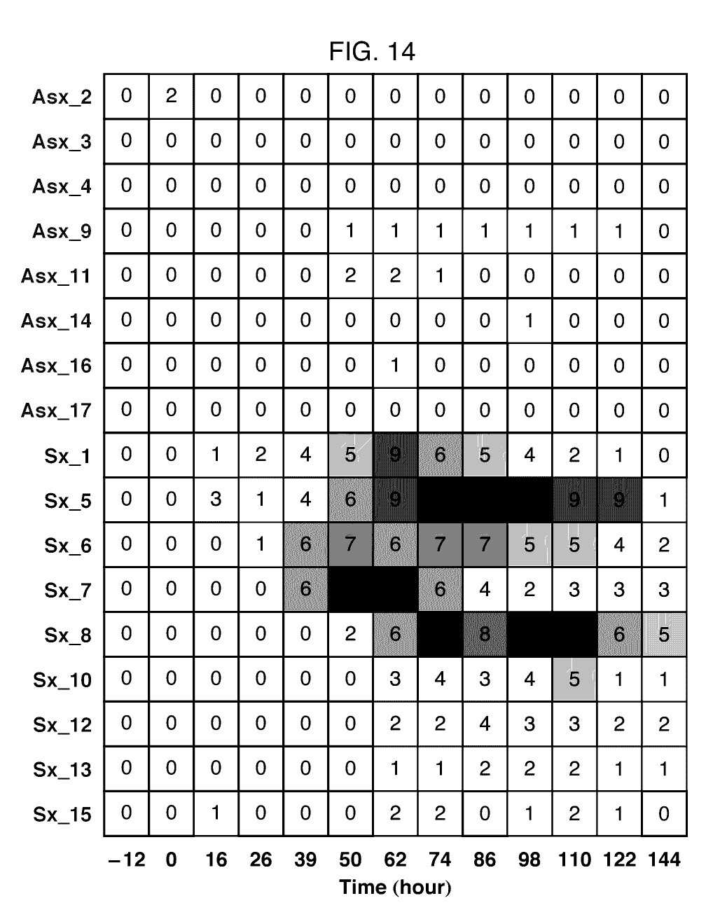

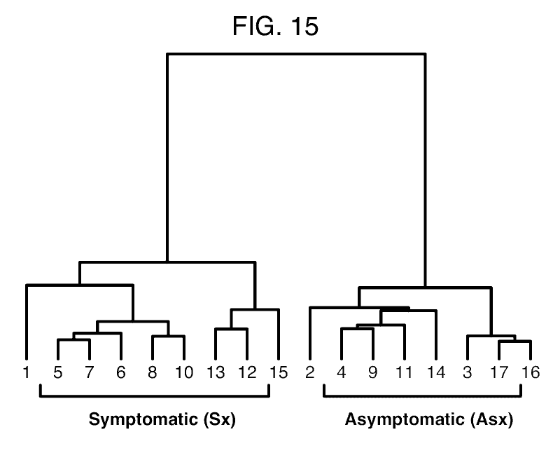

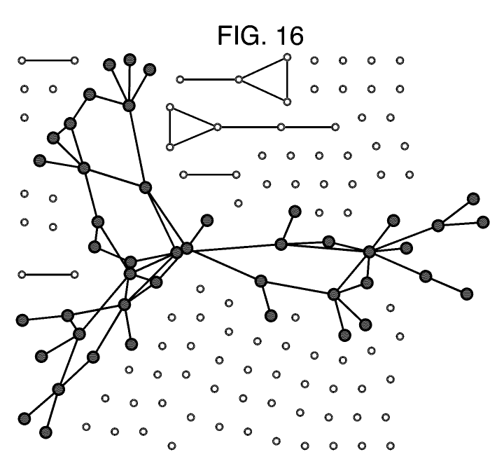

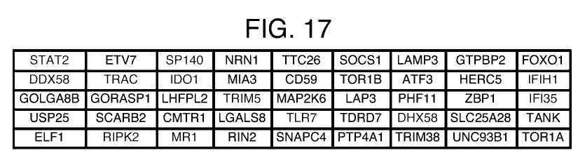

The algorithm was also applied to predicting onset of influenza. The data was retrieved from GEO database with accession ID GSE30550. The data consists of temporal expression data of ˜12,000 genes observed at an 8-hour interval over a 108-hour period after 17 volunteer subjects were inoculated with influenza virus. The observation of clinical symptoms divided the studied subjects into symptomatic (Sx) and asymptomatic (Asx) groups. The classification and the progression of clinical symptoms for individual subjects are shown in FIG. 14, Based on the present algorithm, we performed an unsupervised (clinically uninformed) analysis using these time series data sets. The 17 subjects were first hierarchically clustered into two groups based on individual genes' fluctuations over the entire disease progression (shown in FIG. 15). These two groups are in perfect match with the Sx and Asx groups that are differentiated from the clinical observation. Applying the algorithm on such bi-conditional data, we identified a percolating cluster of 45 genes as transition core driving the sudden deterioration in symptomatic subjects. The topological structure of this giant cluster is shown in FIG. 16. Further gene ontology analysis revealed that among these 45 core genes, 12 nucleation genes are associated with viral immune response (FIG. 17, 18).

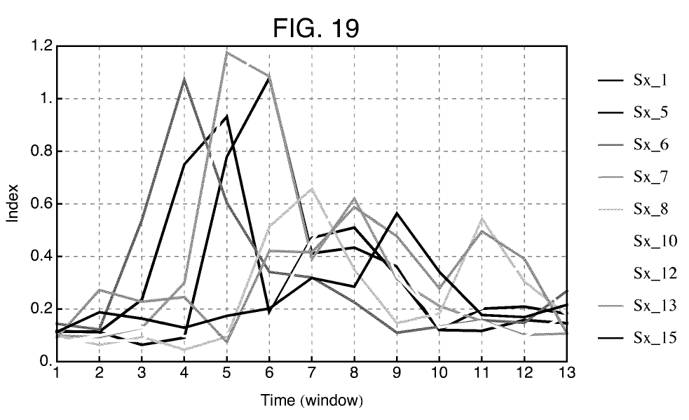

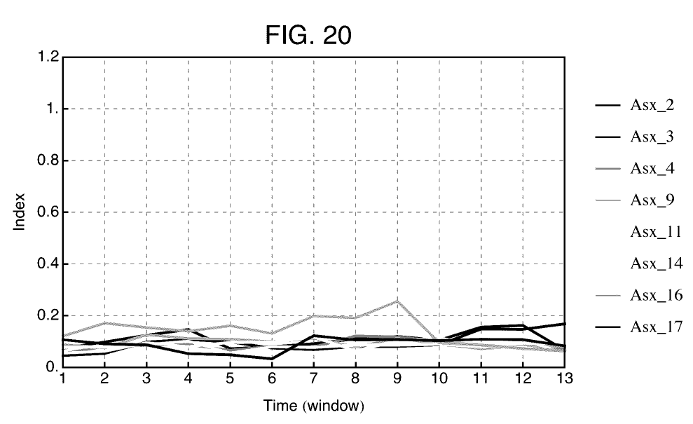

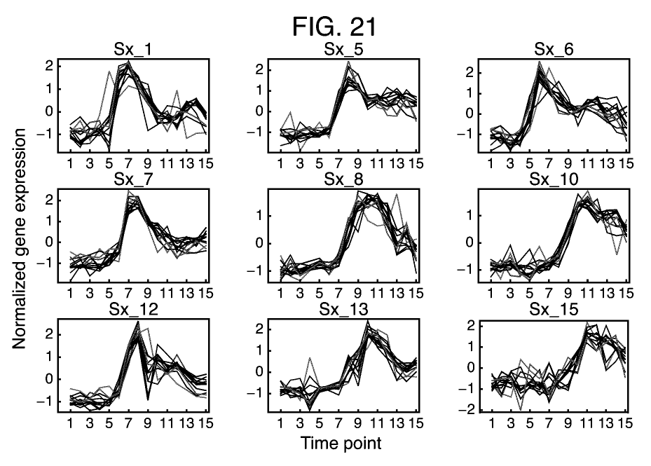

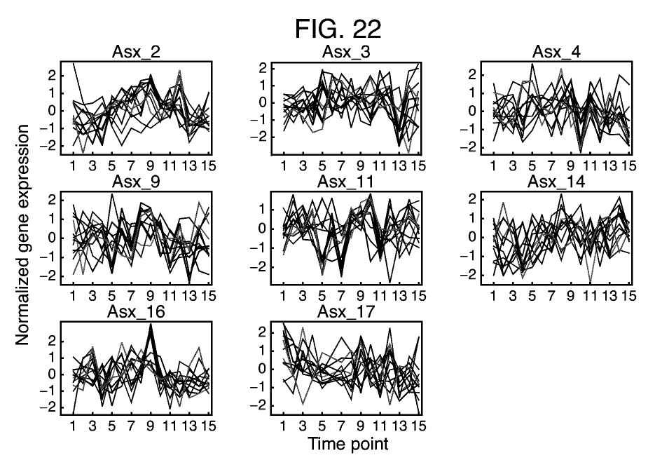

To make prediction of clinical outcomes for individual subjects, we quantify the risk of becoming symptomatic by measuring the above composite index over time. Such index change of the nucleation genes is fundamentally different between symptomatic group (FIG. 19) and asymptomatic (FIG. 20) group. By setting a reasonable cutoff for the index, say, 0.3, one can perfectly distinguish the two groups with 100% of accuracy and sensitivity. Indeed, the maximal peak value of index out of the 8 asymptomatic subjects is below 0.3, whereas the minimal peak value of index out of the 9 symptomatic subjects is higher than 0.5. We next looked into the gene expression profile of nucleation genes for both groups shown respectively in FIG. 21 and FIG. 22. The comparison is made more transparent as one can easily tell the pattern of collaboration between nucleation genes is drastically different between the two groups. In Sx group, the nucleation genes move in sync and collectively undergo sudden and dramatic change, while in Asx group, they move independently in a chaotic fashion.

To predict the time of onset and the severity of clinical symptoms for individual subjects, we compared the time evolution of index change against the progression of influenza symptoms. One can see that the rise of index change is almost always before the actual onset of disease. In addition, the severity of symptom is loosely correlated with the magnitude of index (only one extremal exception for Sx_7, indicating likely personal specificity). These evidences suggest the promising application of nucleation genes as biomarkers for the prognostication and early intervention of complex diseases.

Some applications of embodiments of the current invention can include early detection of complex diseases; predicting financial crises or stock market trendlines; and/or forecasting trend in internet and social network. Some products, processes and/or services can include biomarkers, biochips or image processing systems for early detection of complex diseases; web service or software platforms for automatic and personalized diagnosis based on anonymous health records; trading algorithms for stocks or other financial derivatives; web services for trend analysis based on internet query data or social network data.

Most time series based algorithms focus on stationary processes, while algorithms used in some embodiments of the current invention specifically target critical time points of sudden and dramatic transitions. An embodiment of the current invention identifies individually weak but collectively invasive signals in the pre-transitional stage, leading to early warning and superior predictive power in foresting an imminent critical transition; it can also discover the core set of system variables (e.g., genes forming close community structure both functionally and dynamically) that work as drivers of critical transitions, providing potential manipulating capabilities of early prevention of disease, financial crises, and/or social catastrophes etc.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. It is intended, therefore, that the invention be defined by the scope of the claims that follow and that such claims be interpreted as broadly as is reasonable.

### REFERENCES

Yu, X., Li, G. & Chen, L. Prediction and early diagnosis of complex diseases by edge-network. Bioinformatics (2013).
Zhao, P. et al. Slug is a novel downstream target of MyoD. Temporal profiling in muscle regeneration. J. Biol. Chem. 277, 30091-30101 (2002).
Huang, Y. et al. Temporal dynamics of host molecular responses differentiate symptomatic and asymptomatic influenza a infection. PLoS Genet. 7, e1002234 (2011).

### Ecosystems:

Scheffer, M., Carpenter, S., Foley, J. A., Folke, C. & Walker, B. Catastrophic shifts in ecosystems. Nature 413, 591-596 (2001).
Drake, M. J. & Griffen, D. B. Early warning signals of extinction in deteriorating environments. Nature 467, 456-459 (2010).

### Climate Systems:

Dakos, V. et al. Slowing down as an early warning signal for abrupt climate change. Proc. Natl Acad. Sci. USA 105, 14308-14312 (2008).
Lenton, T. M. et al. Tipping elements in the earth's climate system. Proc. Natl Acad. Sci. USA 105, 1786-1793 (2008).

### Physiological Systems:

McSharry, P. E., Smith, L. A. & Tarassenko, L. Prediction of epileptic seizures: are nonlinear methods relevant? Nature Med. 9, 241-242 (2003).

### Financial Systems:

Kambhu, J., Weidman, S. & Krishnan, N. New Directions for Understanding Systemic Risk: A Report on a Conference Cosponsored by the Federal Reserve Bank of New York and the National Academy of Sciences (The National Academies Press, Washington D.C., 2007).
May, R. M., Levin, S. A. & Sugihara, G. Ecology for bankers. Nature 451, 893-895(2008).

We claim:

1. A method of predicting a transformative event within a multivariable system, comprising:
receiving values for each of a plurality of variables of said multivariable system for a plurality of measurement times over a measurement time period;
selecting, for each of said plurality of measurement times, a plurality of agitated variables as a sub-set of said plurality of variables;
calculating, for each of said plurality of measurement times, a cross correlation coefficient between each pair of agitated variables from said plurality of agitated variables;
identifying connected pairs of agitated variables based on said cross correlation coefficients;
identifying, for each of said plurality of measurement times, all clusters of agitated variables such that each agitated variable within each cluster of agitated variables is a connected pair of agitated variables with at least one other agitated variable therein;
identifying, for each of said plurality of measurement times, a percolating cluster of variables as the largest cluster of agitated variables from all clusters of agitated variables identified for the corresponding measurement time;
receiving at least one nucleation core variable that is known to be associated with said transformative event;
identifying all occurrences of said at least one nucleation core variable in each percolating cluster for each of said plurality of measurement times;
calculating, for each of said plurality of measurement times, a nucleation index based on said all occurrences of said at least one nucleation core variable identified in each percolating cluster for each of said plurality of measurement times;
comparing, for each of said plurality of measurement times, said nucleation index with a predetermined event index; and
predicting said transformative event based on said comparing,
wherein said selecting, for each of said plurality of measurement times, said plurality of agitated variables comprises calculating a measure of time variation of each of said plurality of variables for a local time period around each of said plurality of measurements times such that said local time period is smaller than said measurement time period.

2. The method of claim 1, wherein said identifying connected pairs of agitated variables based on said cross correlation coefficients uses a threshold value for said cross correlation coefficients that, when exceeded in magnitude, identifies the corresponding pairs of agitated variables to be connected.

3. The method of claim 2, wherein said threshold value for said cross correlation coefficients is selected such that exactly N/2 pairs of said agitated variables are identified as connected among N agitated variables selected.

4. The method of claim 1, wherein said plurality of variables of said multivariable system are at least 100 variables.

5. The method of claim 1, wherein said plurality of variables of said multivariable system are at least 1000 variables.

6. The method of claim 1, wherein said selecting, for each of said plurality of measurement times, said plurality of agitated variables comprises calculating a standard deviation of each of said plurality of variables for a local time period around each of said plurality of measurements times such that said local time period is smaller than said measurement time period.

7. The method of claim 1, wherein said receiving at least one nucleation core variable that is known to be associated with said transformative event is receiving a plurality of nucleation core variables that are known to be associated with said transformative event.

8. The method of claim 1, wherein said nucleation index is calculated as a composite index equal to the product of averaged standard deviations of nucleation core variables identified for each measurement time with average absolute Pearson's correlation coefficients between nucleation core variable pairs.

9. The method of claim 1, wherein said receiving at least one nucleation core variable that is known to be associated with said transformative event is a plurality of stock price or market index values and said transformative event within said multivariable system is a stock market event in a financial system.

10. The method of claim 1, wherein said receiving at least one nucleation core variable that is known to be associated with said transformative event is a plurality of protein-quantity values and said transformative event within said multivariable system is a biological event in a biological system.

11. The method of claim 10, wherein said plurality of protein-quantity values correspond to expression of six genes corresponding to myoblast proliferation during regeneration or development of muscle tissue.

12. The method of claim 11, wherein said six genes are TNNT3, MYL2, TCAP, TNNC2, ACTN2, and DMD.

13. The method of claim 10, wherein said plurality of protein-quantity values correspond to expression of eight genes corresponding to myotube formation during regeneration or development of muscle tissue.

14. The method of claim 13, wherein said eight genes are MYL6B, ACTC1, TPM2, MYH8, MYH3, TNNC1, TNNT1, and TNNI1.

15. The method of claim 10, wherein said plurality of protein-quantity values correspond to expression of six genes corresponding to myofiber maturation during regeneration or development of muscle tissue.

16. The method of claim 15, wherein said six genes are TNNT3, MYL2, TCAP, TNNC2, ACTN2, and DMD.

17. The method of claim 10, wherein said plurality of protein-quantity values correspond to expression of four genes corresponding to complete recovery during regeneration or development of muscle tissue.

18. The method of claim 17, wherein said four genes are MYH7, MYH6, MYL3, and TPM3.

19. The method of claim 10, wherein said plurality of protein-quantity values correspond to expression of twelve genes corresponding to onset of influenza.

20. The method of claim 19, wherein said twelve genes are DDX58, IFIH1, IFI35, STAT2, TLR7, TRIM5, DHX58, MR1, SP140, TRAC, IDO1, and RIPK2.

21. A non-transient computer-readable medium comprising computer-executable code for predicting a transformative event within a multivariable system, which when executed by a computer, causes the computer to:
receive values for each of a plurality of variables of said multivariable system for a plurality of measurement times over a measurement time period;
select, for each of said plurality of measurement times, a plurality of agitated variables as a sub-set of said plurality of variables;
calculate, for each of said plurality of measurement times, a cross correlation coefficient between each pair of agitated variables from said plurality of agitated variables;
identify connected pairs of agitated variables based on said cross correlation coefficients;
identify, for each of said plurality of measurement times, all clusters of agitated variables such that each agitated variable within each cluster of agitated variables is a connected pair of agitated variables with at least one other agitated variable therein;
identify, for each of said plurality of measurement times, a percolating cluster of variables as the largest cluster of agitated variables from all clusters of agitated variables identified for the corresponding measurement time;
receive at least one nucleation core variable that is known to be associated with said transformative event;
identify all occurrences of said at least one nucleation core variable in each percolating cluster for each of said plurality of measurement times;
calculate, for each of said plurality of measurement times, a nucleation index based on said all occurrences of said at least one nucleation core variable identified in each percolating cluster for each of said plurality of measurement times;
compare, for each of said plurality of measurement times, said nucleation index with a predetermined event index; and
predict said transformative event based on said comparing,
wherein said selecting, for each of said plurality of measurement times, said plurality of agitated variables comprises calculating a measure of time variation of each of said plurality of variables for a local time period around each of said plurality of measurements times such that said local time period is smaller than said measurement time period.

22. A system for predicting a transformative event within a multivariable system comprising a computer, said computer being configured to:
receive values for each of a plurality of variables of said multivariable system for a plurality of measurement times over a measurement time period;
select, for each of said plurality of measurement times, a plurality of agitated variables as a sub-set of said plurality of variables;
calculate, for each of said plurality of measurement times, a cross correlation coefficient between each pair of agitated variables from said plurality of agitated variables;
identify connected pairs of agitated variables based on said cross correlation coefficients;
identify, for each of said plurality of measurement times, all clusters of agitated variables such that each agitated variable within each cluster of agitated variables is a connected pair of agitated variables with at least one other agitated variable therein;
identify, for each of said plurality of measurement times, a percolating cluster of variables as the largest cluster of agitated variables from all clusters of agitated variables identified for the corresponding measurement time;
receive at least one nucleation core variable that is known to be associated with said transformative event;
identify all occurrences of said at least one nucleation core variable in each percolating cluster for each of said plurality of measurement times;
calculate, for each of said plurality of measurement times, a nucleation index based on said all occurrences of said at least one nucleation core variable identified in each percolating cluster for each of said plurality of measurement times;
compare, for each of said plurality of measurement times, said nucleation index with a predetermined event index; and
predict said transformative event based on said comparing,
wherein said selecting, for each of said plurality of measurement times, said plurality of agitated variables comprises calculating a measure of time variation of each of said plurality of variables for a local time period around each of said plurality of measurements times such that said local time period is smaller than said measurement time period.
